(19) United States
(12) Patent Application Publication
(10) Pub. No.: US 2003/0179441 A1
(43) Pub. Date: Sep. 25, 2003

(54) Polarisation insensitive optical amplifiers

(76) Inventors: Ralf-Dieter Pechstedt, Oxfordshire (GB); Ivan Evans, Oxford (GB)

Correspondence Address: Mark D. Saralino, Renner, Otto, Boisselle & Sklar, LLP, Nineteenth Floor, 1621 Euclid Avenue, Cleveland, OH, 44115, US

(21) Appl. No.: 10/390,196

(22) Filed: Mar. 17, 2003

(30) Foreign Application Priority Data
Mar. 19, 2002 (GB) 0206468.1

(51) Int. Cl. H01S 3/00

(52) U.S. Cl. 359/337

(57) ABSTRACT

A planar waveguide module has integrally formed thereon a waveguide and, in sequence along the optical transmission path, a first LOA, a 90° polarisation rotator, a VOA and a second LOA. The LOAs and are gain-clamped SOAs having linear gain responses over the required wavelength range. In the absence of the polarisation rotator the PDGs of the LOAs would be added together to provide an overall PDG of approximately twice the PDG of a single LOA. However the inclusion of the polarisation rotator between the LOAs causes a substantial reduction in the overall PDG. If TE polarised light is supplied to the first LOA, the polarisation rotator will cause TM polarised light to be supplied to LOA, and accordingly the overall gain of the module will equal Gain(TE, LOA 3)+Gain(TM, LOA 7)−attenuation. On the other hand, if TM polarised light is supplied to the first LOA, the overall gain will be Gain(TM, LOA 3)+Gain(TE, LOA 7)−attenuation which is substantially the same as the gain for the inputted TE polarised light. Such a polarisation insensitive optical amplifier is advantageous since it is easily fabricated using known fabrication techniques, for example on a planar lightwave circuit on a SOI platform, and without having to modify the amplifying means.

The present invention relates to optical amplifiers that are substantially insensitive to the polarisation of the optical signals to be amplified.

### BACKGROUND OF THE INVENTION

It is well known to incorporate semiconductor optical amplifiers (SOAs) within an optical device having a waveguide structure in order to amplify an optical signal. Such SOAs typically exhibit polarisation dependent behaviour in that different polarisation components are subjected to different gains with the result that the gain of a particular SOA will change with variation in the polarisation of the optical signal to be amplified.

“Polarisation Insensitive Optical Amplifier consisting of Two Semiconductor Laser Amplifiers and a Polarisation Insensitive Isolator in Series”, M. Koga and T. Matsumoto, IEEE Photonics Technology Letters, Vol. 1, No. 12, December 1989, discloses an arrangement utilising a polarisation insensitive isolator between two SOAs in order to eliminate the cavity coupling between the two SOAs and a 90° polarisation rotator to decrease the polarisation dependence of the signal gain. However special alignment measures are required to implement the isolator in such an arrangement, and there is no provision for gain clamping (and accordingly no means for varying the overall gain if the amplifier gain is clamped). The fabrication of such a polarisation insensitive isolator within a planar lightwave circuit presents a number of practical difficulties.

SOAs are also known which are gain-clamped so as to have a substantially linear gain response over the wavelength range of the optical signal. Such SOAs are known as linear optical amplifiers (LOAs). “Polarisation-Insensitive Clamped-Gain SOA with Integrated Spot-Size Convertor and DBR Gratings for WDM Applications at 1.55 μm Wavelength”, M. Bachmann et al., Electronics Letters, Vol. 32, No. 22, p. 2076 (1996) discloses such a gain-clamped SOA incorporating input and output DBR gratings for wavelength selective feedback. The SOA incorporates an active separate confinement heterostructure consisting of InGaAsP bulk material and two cavity layers, a low tensile strain being introduced in the bulk material to achieve polarisation independent gain. However the introduction of such low tensile strain to achieve polarisation independent operation may prove difficult within complex structures.

It is an object of the invention to provide an optical amplifier which is substantially polarisation insensitive and which can be fabricated within an optical device using SOI technology, for example.

### SUMMARY OF THE INVENTION

According to the present invention there is provided a polarisation insensitive optical amplifier comprising comprising waveguide means, polarisation rotating means for rotating the polarisation of an optical signal, amplifying means for receiving an optical input signal supplied to the waveguide means and for supplying an amplified optical signal with a first polarisation dependent gain (PDG) to the polarisation rotating means, and for receiving an optical output signal from the polarisation rotating means and for outputting an amplified optical output signal with a second polarisation dependent gain (PDG) from the waveguide means such that the effect of the first and second polarisation gains applied by the amplifying means is decreased by the polarisation rotation, wherein at least the waveguide means and the polarisation rotating means are integrally formed on a planar lightwave circuit.

Such a polarisation insensitive optical amplifier is advantageous since it is easily fabricated using known fabrication techniques, for example on a planar lightwave circuit on a SOI platform, and without having to modify the amplifying means.

Optical attenuating means, such as a variable optical attenuator (VOA), may be provided for attenuating the optical signal, in order to allow the overall gain of the arrangement to be varied as required.

In one embodiment of the invention the amplifying means incorporates at least one linear optical amplifier (LOA) incorporating gain clamping. In this case the provision of a VOA enables the overall gain to be adjusted in spite of the gain clamping of the LOAs.

In an alternative embodiment of the invention the amplifying means incorporates at least one semiconductor optical amplifier (SOA) which is not gain clamped. In this case the provision of a VOA may not be necessary since the overall gain may be adjusted by varying the gain of the SOA.

The polarisation rotating means may be constituted by a 90° converter or by two 45° converters (one on each side of the VOA, for example).

### BRIEF DESCRIPTION OF THE DRAWINGS

For a better understanding of the present invention and to show how the same may be carried into effect, reference will now be made, by way of example, to the accompanying drawings in which:

FIG. 1 is a schematic diagram illustrating a first embodiment of the invention;

FIG. 2 is a schematic diagram illustrating a second embodiment of the invention;

FIG. 3 is a schematic diagram of a suitable polarisation rotator for use in the illustrated embodiments of the invention;

FIGS. 4 and 5 are schematic diagrams illustrating third and fourth embodiments of the invention;

FIG. 6 is a graph illustrating the effect on noise of attenuator position in the illustrated embodiments of the invention; and

FIGS. 7 and 8 are schematic diagrams illustrating fifth and sixth embodiments of the invention.

### DETAILED DESCRIPTION OF THE DRAWINGS

The preferred embodiments of polarisation insensitive optical amplifier to be described below incorporate two LOAs and a single VOA hybridised in a planar waveguide module formed on a silicon chip for simultaneous amplification of several wavelength division multiplexed (WDM) optical communication channels. However it will be appreciated that the invention is applicable to many other types of optical device for use in optical communication and other applications.

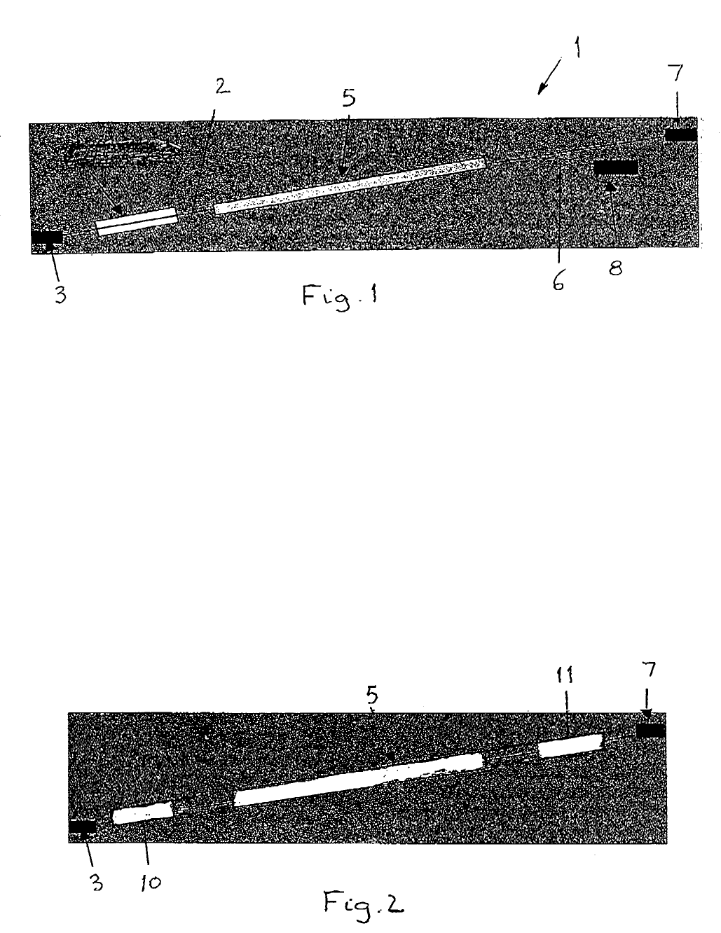

The planar waveguide module 1 shown in FIG. 1 comprises a waveguide 2 defining an optical transmission path and, in sequence along the optical transmission path, a first LOA 3, a 90° polarisation rotator 4, a VOA 5 and a second LOA 7. The LOAs 3 and 7 are gain-clamped SOAs having linear gain responses over the required wavelength range. The waveguide 2, the polarisation rotator 4 and the VOA 5 are integrally formed on the chip by known fabrication steps, and the LOAs 3 and 7 are then hybridised onto the chip, typically by being flip-bonded within respective recesses in the waveguide 2. A normally off VOA is particularly advantageous in such an arrangement as it only requires power when attenuating the optical signal.

In operation of the module of FIG. 1 to amplify several WDM channels, the channels are initially amplified by the LOA 3 prior to the polarisation of the output signal from the LOA 3 being rotated through 90° by the polarisation rotator 4. The channel signals are then attenuated by the VOA 5 in dependence on an electrical control signal prior to being further amplified by the LOA 7 and outputted from the device. The two LOAs are fabricated on the same wafer, preferably at positions adjacent to one another, and therefore have similar PDGs. In the absence of the polarisation rotator 4 the PDGs of the LOAs would be added together to provide an overall PDG of approximately twice the PDG of a single LOA.

However the inclusion of the integrated polarisation rotator 4 between the LOAs 3 and 7 causes a substantial reduction in the overall PDG. If TE polarised light is supplied to the input of the LOA 3, the polarisation rotator 4 will cause TM polarised light to be supplied to the VOA 5 and the LOA 7, and accordingly the overall gain of the module will equal Gain(TE, LOA 3)+Gain(TM, LOA 7)−attenuation. On the other hand, if TM polarised light is supplied to the input of the LOA 3, the overall gain will be Gain(TM, LOA 3)+Gain(TE, LOA 7)−attenuation which is substantially the same as the gain for the inputted TE polarised light.

The module optionally also includes a tap-off coupler 6 for conducting a small proportion of the light travelling along the waveguide 2 to a monitor photodiode 8 which supplies an electrical output signal indicative of the power of the light emitted by the VOA 5. The gain of the module may be adjusted by varying the drive current supplied to the VOA 5 which is controlled by an electrical control circuit. Such control may be effected in dependence on the output signal from the monitor photodiode 8 indicative of the power output of the VOA 5.

FIG. 2 shows an alternative embodiment in which, in place of the 90° polarisation rotator 4, two 45° polarisation rotators 10 and 11 (differing from the polarisation rotator 4 only in respect of their lengths) are positioned on either side of the VOA 5 along the waveguide 2. Such an arrangement is possible since the VOA arrangement used is substantially polarisation insensitive. In this case the polarisation rotator 11 may be positioned either before or after the tap-off coupler where this is provided.

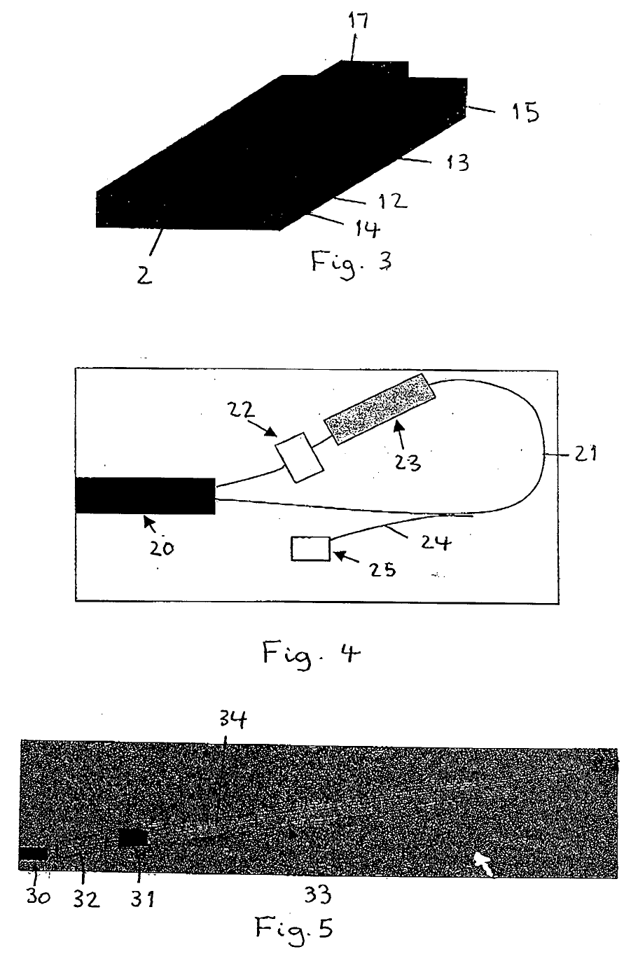

The or each polarisation rotator 4 may be formed along the waveguide in various ways, for example by special periodic waveguide structures or by employing tilted waveguide sections. FIG. 3 shows a possible form of polarisation rotator which may be used in these arrangements and which incorporates a special periodic waveguide structure in order to provide the required polarisation rotation. More particularly FIG. 3 shows the waveguide 2 formed by etching an epitaxial layer on a thin silicon layer 12 on a silicon substrate 14, and a cladding layer 15. Cutouts 16 are etched in the layer 15 so as to cause periodic variation of the refractive index of the waveguide along the optical transmission path. As a result the polarisation of light passing through the polarisation rotator is rotated to such an extent that, for example, TE polarised light is converted to TM polarised light, and TM polarised light is converted to TE polarised light.

Assuming ideal performance of the polarisation rotator, the extent of the polarisation insensitivity of such a device will mainly depend on how well the PDGs of the two LOAs are matched. Such matching can be optimised if the LOAs originate from neighbouring positions on the wafer on which they are fabricated.

In a further embodiment of the invention shown in FIG. 4 the two LOAs (which are typically made of III-V materials and are from neighbouring positions on the wafer) are incorporated in a specially designed double ridge amplifier structure 20 with the light output of one LOA of this structure 20 being coupled to an input of a looped waveguide 21, and the output of the looped waveguide 21 being coupled to a light input of the other LOA of the structure 20. The looped waveguide 21 is provided with a 90° polarisation rotator 22, a VOA 23, and optionally a tap-off coupler 24 and monitor photodiode 25. It is possible to conceive of a variation of such an arrangement in which a polarisation maintaining (PM) optical fibre is used in place of the loop waveguide 21, in which case the required polarisation rotator may be formed by a 90° twist in the optical fibre.

In a further variation of the illustrated embodiments an optical isolator may be provided along the waveguide between the two LOAs.

However the invention is not limited to the particular embodiments described above, and it is possible to conceive of other embodiments which are also within the scope of the invention claimed. For example, in place of the polarisation rotators shown in FIGS. 1 and 2, a single 45° polarisation rotator 40 may be used in association with a mirror 41 which serves to reflect the optical signal along its path so that the signal passes through the polarisation rotator 40 twice and is thereby subjected to a 90° rotation, as shown in FIG. 7. The PDL is compensated if the correct polarisation phase matching gap is provided between the end of the polarisation rotator 40 and the mirror 41. This embodiment has the advantage that only a single LOA 3 is required so that it is no longer necessary to closely match the characteristics of two LOAs, and only a single input/output port is required. A circulator can be used to separate the input and output channels. Alternatively the LOA can be provided in one arm of a Mach-Zehnder interferometer.

Alternatively, as shown in FIG. 8, a polarisation splitter 50 may be provided at the output of the waveguide for splitting the optical signal into two polarisation components, with the output ports of the splitter 50 being connected to opposite ends of a 90° polarisation rotator/converter 51 within a waveguide loop 52. The splitter 50 and rotator 51 can either be integrated or provided off-chip. Furthermore the rotator may simply be constituted by a twisted PM optical fibre in a further modification.

It has been found that, when integrating the two LOAs and single VOA within a module, the noise figure of the system is highly dependent on the order in which these components are arranged along the waveguide. In particular it has been found that the noise figure can be kept to a substantially constant low level if the two LOAs are cascaded and the VOA is placed last in the sequence along the waveguide. FIG. 5 shows an embodiment in which the two LOAs 30 and 31 are separated only by a 90° polarisation rotator 32, and the VOA 33 is located after both LOAs 30 and 31 along the waveguide 34.

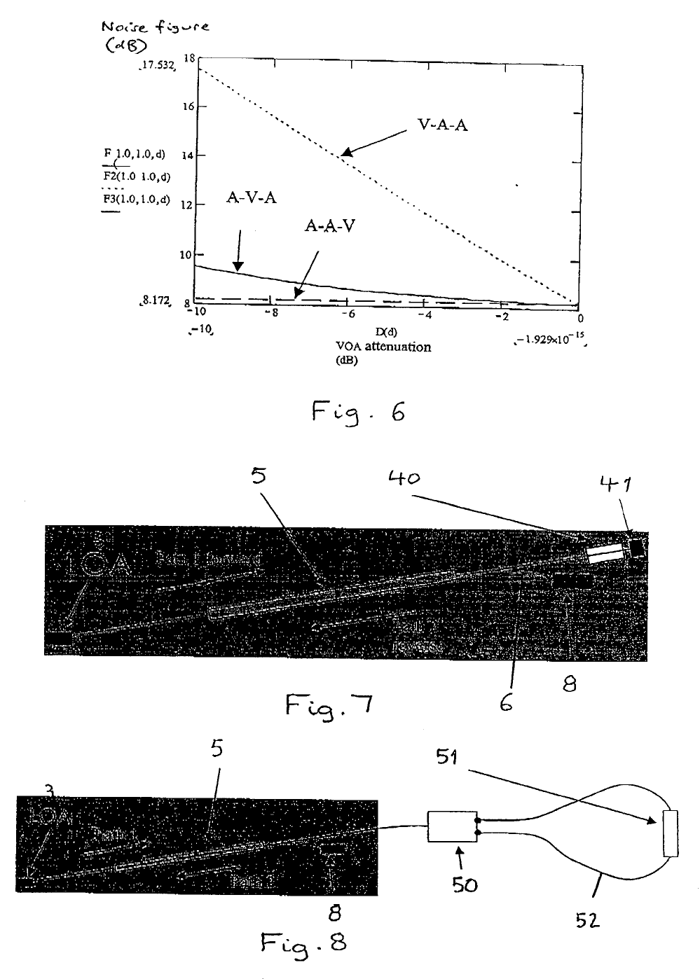

FIG. 6 is a graph showing the effect of the position of the VOA on the noise performance of the module. The model used in plotting the graph assumes a 13 dB gain with a noise figure of 8 dB for both LOAs and coupling losses at each interface of 0 dB. The broken line denoted V-A-A shows the variation of the noise with the level of the applied attenuation for a non-illustrated embodiment in which the VOA is placed before the two LOAs along the waveguide. The solid line denoted A-V-A shows the variation of the noise for the embodiments of FIGS. 1, 2 and 4 in which the VOA is placed between the LOAs, whereas the broken line denoted by A-A-V shows the variation of the noise for the embodiment of FIG. 5 in which the VOA is placed after the two LOAs along the waveguide.

For the V-A-A configuration, the broken line denoted V-A-A shows that this configuration provides a high noise figure which is additionally highly dependent on the level of attenuation applied by the VOA. On the other hand, for the A-V-A configuration, the solid line denoted A-V-A shows that, although the noise level is decreased, the noise varies significantly with variation in the applied attenuation. This is undesirable as tuning of the gain of the module will result in a worsening of the system. On the other hand, for the A-A-V configuration, the broken line denoted by A-A-V (corresponding to the configuration of FIG. 5) shows that a low level of noise is obtained with such a configuration which remains substantially constant as the level of attenuation is changed. The losses at the interfaces will not affect these general conclusions.

1. A polarisation insensitive optical amplifier comprising waveguide means, polarisation rotating means for rotating the polarisation of an optical signal, amplifying means for receiving an optical input signal supplied to the waveguide means and for supplying an amplified optical signal with a first polarisation dependent gain (PDG) to the polarisation rotating means, and for receiving an optical output signal from the polarisation rotating means and for outputting an amplified optical output signal with a second polarisation dependent gain (PDG) from the waveguide means such that the effect of the first and second polarisation gains applied by the amplifying means is decreased by the polarisation rotation, wherein at least the waveguide means and the polarisation rotating means are integrally formed on a planar lightwave circuit.

2. An optical amplifier according to claim 1, wherein the amplifying means is hybridised on the planar lightwave circuit.

3. An optical amplifier according to claim 1, wherein the polarisation rotating means comprises a periodic structure providing a periodically varying refractive index along the waveguide means.

4. An optical amplifier according to claim 1, wherein optical attenuating means is provided for attenuating the optical signal.

5. An optical amplifier according to claim 4, wherein the optical attenuating means is a variable optical attenuator (VOA).

6. An optical amplifier according to claim 4, wherein the optical attenuating means is positioned to receive the amplified optical signal with the first polarisation dependent gain (PDG) prior to further amplification with the second polarisation dependent gain (PDG).

7. An optical amplifier according to claim 1, wherein the amplifying means incorporates at least one linear optical amplifier (LOA) having gain clamping.

8. An optical amplifier according to claim 1, wherein the amplifying means incorporates at least one semiconductor optical amplifier (SOA) which is not gain clamped.

9. An optical amplifier according to claim 1, wherein the polarisation rotating means is a 90° converter.

10. An optical amplifier according to claim 1, wherein the polarisation rotating means comprises two 45° converters.

11. An optical amplifier according to claim 1, wherein a tap-off coupler and associated photodetector are provided for monitoring the optical signal in the waveguide means.

12. An optical amplifier according to claim 11, wherein two tap-off couplers and two associated photodetectors are provided for monitoring the optical signal in the waveguide means before and after attenuating means.

13. An optical amplifier according to claim 1, wherein the amplifying means comprises first amplifying means having a first polarisation dependent gain (PDG) for receiving the optical input signal and for supplying an amplified optical signal to the polarisation rotating means, and second amplifying means having a second polarisation dependent gain (PDG) for receiving the optical output signal from the polarisation rotating means.

14. An optical amplifier according to claim 13, wherein isolating means is provided between the first and second amplifying means.

15. An optical amplifier according to claim 13 or 14, wherein the amplifying means comprises a double-ridge amplifier structure, and the waveguide means is formed by a looped waveguide interconnecting the first and second amplifying means of the double-ridge amplifier structure.

16. An optical amplifier according to claim 1, wherein the amplifying means comprises a single amplifier and the arrangement is such that the optical signal is returned along its path after being amplified by the amplifier with the first polarisation dependent gain (PDG) so that the optical signal is amplified by the amplifier with the second polarisation dependent gain (PDG) in a second pass through the amplifier.

17. An optical amplifier according to claim 16, wherein a mirror is provided for returning the optical signal along its path.

18. An optical amplifier according to claim 16, wherein a polarisation splitter having its output ports coupled to opposite ends of the polarisation rotating means is provided for returning the optical signal along its path.

19. An optical amplifier according to claim 1, wherein the planar lightwave circuit is a SOI (silicon-on-insulator) planar lightwave circuit.
